(19) United States
(12) Patent Application Publication
(10) Pub. No.: US 2015/0184992 A1
(43) Pub. Date: Jul. 2, 2015

(54) ELECTRONIC DEVICE AND METHOD OF OPERATING APPLICATION THEREOF

(71) Applicant: Samsung Electronics Co., Ltd., Suwon-si (KR)

(72) Inventors: Chang-youl LEE, Suwon-si (KR); Hyun-jun PARK, Seoul (KR)

(73) Assignee: SAMSUNG ELECTRONICS CO., LTD., Suwon-si (KR)

(21) Appl. No.: 14/472,432

(22) Filed: Aug. 29, 2014

(30) Foreign Application Priority Data
Dec. 30, 2013 (KR) 10-2013-0167301

(51) Int. Cl. G01B 7/00; G05B 15/02

(52) U.S. Cl. CPC G01B 7/003; G05B 15/02; G01B 2210/58

(57) ABSTRACT

An electronic device connectable to at least one external device includes a plurality of sensors configured to be activated in response to the at least one external device being located within a predetermined distance, a detector configured to, in response to at least one sensor from among the plurality of sensors being activated, output a signal corresponding to the activated sensor, and a controller configured to receive the signal corresponding to the activated sensor, determine a location of the at least one external device, and execute an application corresponding to the location of the at least one external device.

### CROSS-REFERENCE TO RELATED APPLICATIONS

This application claims priority under 35 U.S.C. §119 from Korean Patent Application No. 10-2013-0167301, filed in the Korean Intellectual Property Office on Dec. 30, 2013, the disclosure of which is incorporated herein by reference.

### BACKGROUND OF THE INVENTION

1. Field of the Invention

The present general inventive concept relates to an electronic device and a method of executing an application thereof, and more particularly, to an electronic device which determines a location of an external device connectable to the electronic device with respect to the electronic device and executes an application corresponding to the location of the external device automatically, and a method thereof.

2. Description of the Related Art

An electronic device including a mobile device has been developed to provide or store various functions and information. In addition, in order to provide a user with more extended functions and thus, to improve user convenience, solutions to connect a plurality of devices have been developed.

According to a conventional electronic device, a user needs to select and execute a program necessary to connect a plurality of electronic devices such as a smart phone, a tablet PC, etc. FIGS. 1 and 3 are provided to describe a method for connecting a plurality of electronic devices.

As illustrated in FIG. 1, if a user wishes to connect a tablet PC 13 to a side of a display of a notebook PC 11 to use the tablet PC 13 as a supplemental monitor, the user needs to manually search, select, and execute an application 100 illustrated in FIG. 2 in addition to a connection operation between the notebook PC 11 and the tablet PC 13 and then input setting information regarding which electronic device will be used as a main monitor and which electronic device will be used as a supplemental monitor.

In addition, as illustrated in FIG. 3, if a user wishes to connect a tablet PC 33 to a lower side of a notebook PC 31 to use the tablet PC 33 as a track pad, the user also needs to manually search, select, and execute an application to use the tablet PC 33 as a track pad and input necessary setting information.

That is, a user needs to search, select, and execute an application and input setting information whenever the user wishes to connect and use a plurality of electronic devices, thereby taking a lot of time and causing inconvenience.

Accordingly, there is a need to develop an electronic device which may automatically execute an application necessary to perform a function corresponding to a connection location of an external device with respect to the electronic device.

### SUMMARY OF THE INVENTION

The present general inventive concept provides an electronic device which may determine a location of an external device connectable to one electronic device with respect to the electronic device and execute an application according to the determined location automatically, a method thereof, and a computer-readable medium to execute the method.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic device connectable to at least one external device, the electronic device including a plurality of sensors configured to be activated in response to the at least one external device being located within a predetermined distance, a detector configured to, in response to at least one sensor from among the plurality of sensors being activated, output a signal corresponding to the activated sensor, and a controller configured to receive the signal corresponding to the activated sensor, determine a location of the at least one external device, and execute an application corresponding to the location of the at least one external device.

The controller may determine that the at least one external device is located within the predetermined distance from the activated sensor from among the plurality of sensors.

The electronic device may further include a communicator configured to transmit/receive data to/from the at least one external device.

The controller may determine a type of the at least one external device based on data received from the at least one external device, and execute the application corresponding to the type and location of the at least one external device.

The controller, in response to setting information being input from the application, may control the at least one external device to perform an operation corresponding to the setting information.

The electronic device may further include a storage configured to store the application which is executed in accordance with the location of the at least one external device.

The plurality of sensors may include a Hall IC sensor, and in response to a magnetic field with more than a predetermined magnitude being detected by one of the plurality of sensors, the sensor which detects the magnetic field may be activated.

The controller may provide a User Interface (UI) for changing the application which is executed in accordance with the location of the at least one external device.

The foregoing and/or other features and utilities of the present general inventive concept may also be achieved by providing a method of executing an application of an electronic device connectable to at least one external device, the method including, in response to the at least one external device being located within a predetermined distance from one of a plurality of sensors, activating at least one of the plurality of sensors, outputting a signal corresponding to the activated sensor, and receiving a signal corresponding to the activated sensor, determining a location of the at least one external device, and executing an application corresponding to the location of the at least one external device.

The method may further include determining that the at least one external device is located within the predetermined distance from the activated sensor.

The method may further include transmitting/receiving data to/from the at least one external device.

The method may further include determining a type of the at least one external device based on data received from the at least one external device and executing the application corresponding to the type and location of the at least one external device.

The method may further include receiving setting information from the application and controlling the at least one external device to perform an operation corresponding to the setting information.

The method may further include storing the application which is executed in accordance with the location of the at least one external device.

The plurality of sensors may include a Hall IC sensor, and the method may further include, in response to a magnetic field with more than a predetermined magnitude being detected by one of the plurality of sensors, activating the sensor which detects the magnetic field.

The method may further include providing a User Interface (UI) for changing the application which is executed in accordance with the location of the at least one external device.

The foregoing and/or other features and utilities of the present general inventive concept may also be achieved by providing a non-transitory computer-readable medium containing computer-readable codes as a program to execute a method described above or hereinafter.

The foregoing and/or other features and utilities of the present general inventive concept may also be achieved by providing an electronic device connectable to at least one external device, the electronic device including a plurality of sensors disposed at different locations, a storage to store a plurality of different applications corresponding to the respective sensors, and a controller to automatically execute one of the plurality of different applications according to activation of one of the sensors.

The controller may display a user interface on a display according to the executed application, and the user interface may include a first window to display the external device with locations of the sensors to correspond to modes, and a second window to display the applications corresponding to the modes .

The controller may execute the application corresponding to information on the at least one external device and the activation of the one of the sensors.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1 to 3 are views provided to explain a method for connecting a plurality of electronic devices;

FIG. 4 is a block diagram provided to explain an electronic device according to an exemplary embodiment;

FIGS. 5 and 6 are views provided to explain an electronic device 400 according to an exemplary embodiment;

FIG. 7 is a view provided to explain a method for executing an application corresponding to the type and location of an external device according to an exemplary embodiment;

FIG. 8 is a view provided to explain a UI for setting the type of application which is executed automatically according to an exemplary embodiment; and

FIG. 9 is a view provided to explain a method for executing an application of an electronic device according to an exemplary embodiment.

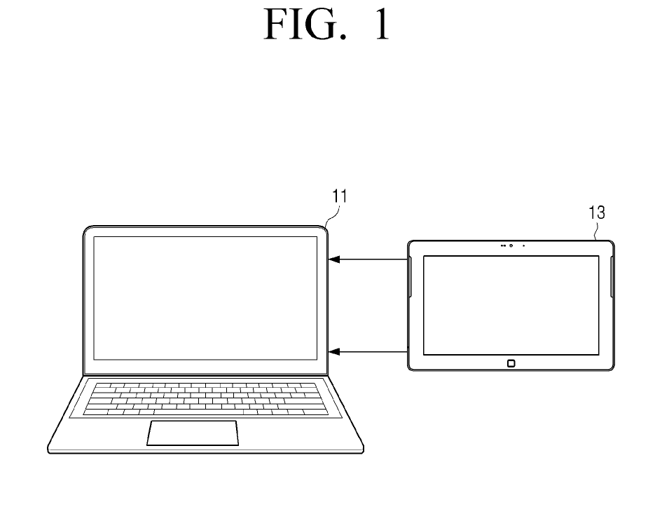

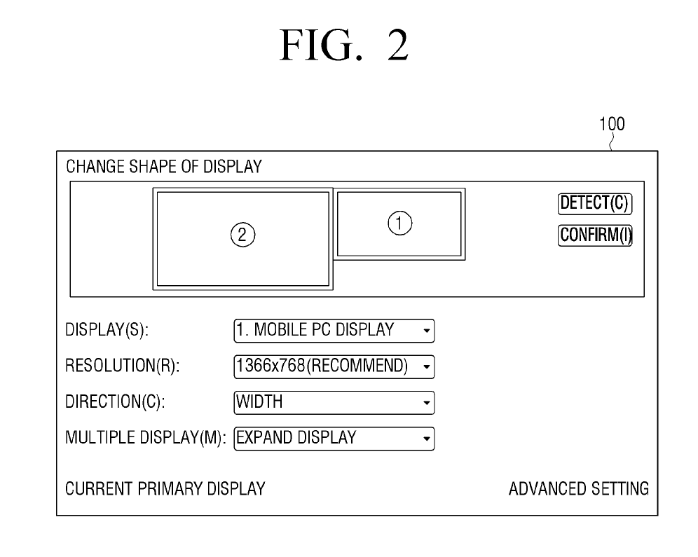

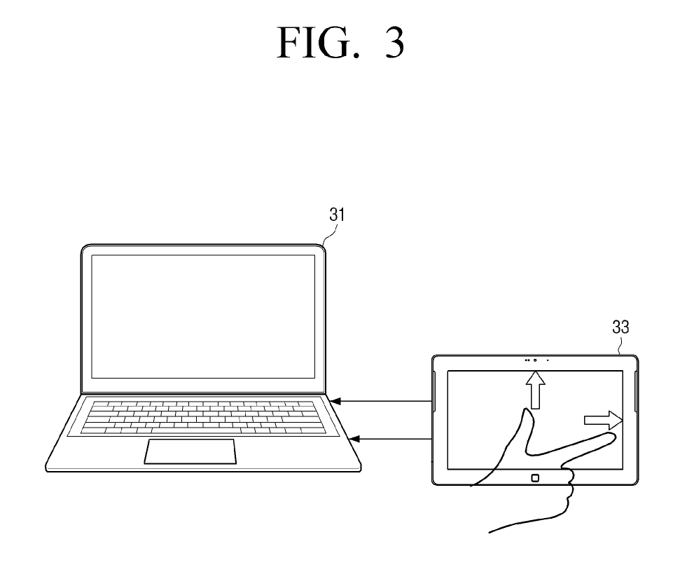

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

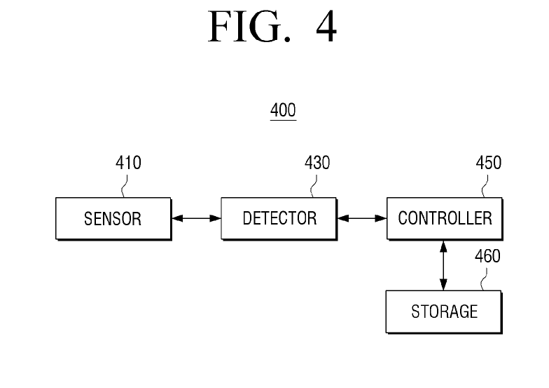

FIG. 4 is a block diagram illustrating an electronic device 400 according to an exemplary embodiment of the present general inventive concept. Referring to FIG. 4, the electronic device 400 includes a sensor 410, a detector 430, and a controller 450.

The electronic device 400 of FIG. 4 may also include elements and structures to perform one or more functions of the electronic device 400. Since the elements and the structures are well known, detail descriptions and illustration thereof will be omitted.

The electronic device 400 illustrated in FIG. 4 may be a notebook PC, but is not limited thereto. The electronic device 400 may be various electronic devices which can be connectable to other external devices such as smart phone, PDA, tablet PC, MFP, printer, etc.

The sensor 410 is activated when at least one external device is located within a predetermined distance from the electronic device 400. FIG. 4 illustrates that the electronic device 400 includes only one sensor 410, but the electronic device 400 may be configured to have a plurality of sensors 410 at different locations.

Meanwhile, according to an exemplary embodiment, a plurality of sensors 410 may be a Hall IC sensor. The Hall IC sensor is activated when a magnetic field with more than a predetermined magnitude is detected, and uses a Hall effect where in response to the magnetic field being applied to a conductor with an electric current, a voltage is generated in a vertical direction (right angle) with respect to the electric current and the magnetic field.

Accordingly, if the sensor 410 is a Hall IC sensor, and an external device to be connected to the electronic device 400 includes a magnetic material, the sensor 410 is activated when the external device approaches or is disposed within a predetermined distance from the sensor 410.

In response to at least one sensor from among a plurality of sensors being activated, the detector 430 outputs a signal corresponding to the activated sensor. For example, if the electronic device 400 is a notebook PC including a total of three Hall IC sensors disposed on an upper side, a left side, and a right side of a screen of a display unit of the electronic device 400, respectively, a user attaches (or dispose) an external device, such as a tablet PC, to the left side of the notebook PC 400 and uses the external device, and the tablet PC includes a magnetic material, the Hall IC sensor at the left side of the notebook PC is activated. In this case, the detector 430 outputs a signal corresponding to the Hall IC sensor disposed on the left side of the screen of the activated notebook PC.

The controller 450 receives the signal corresponding to the activated sensor from the detector 430, determines a location of the external device with respect to the electronic device 400, and executes an application corresponding to the location of the external device. For example, if the electronic device 400 is a notebook PC, and a user wishes to connect a tablet PC which is an external device to the left side of the screen of the notebook PC, the sensor 410 on the left side of the screen of the notebook PC is activated.

The detector 430 outputs a signal corresponding to the sensor of the left side of the screen of the activated notebook PC, and the controller receives the signal, determines that the tablet PC which is the external device is to be connected to the left side of the screen of the notebook PC, and executes the corresponding application.

As the user may wish to connect the external device, the tablet PC, to the left side of the notebook PC in order to use the external device as a supplemental monitor, the controller 450 automatically activates the application to input setting information which is necessary to utilize the external device as a supplemental monitor.

By using the application, the user may set a resolution of the external device, a screen direction, etc., and may also set input information regarding which monitor is to be used as a main monitor. In addition, if a user connects the external device to a right side of a keyboard of the notebook PC, the controller 450 may automatically execute an application to input setting information which is necessary to use the external device, for example, the Tablet PC, as a track pad.

The electronic device 400 may further include a storage 460 which stores a plurality of applications which are executed automatically according to a location of the external device with respect to the electronic device 400. In addition, the user may change a type of applications which are executed automatically according to the location of the external device with respect to the electronic device 400.

As described above, the location of the external device to be connected to the electronic device 400 with respect to the electronic device 400 is determined, and an application corresponding to the determined location is executed automatically and thus, a user does not need to search, select, and/or execute the application to set the function of the external device, thereby improving user convenience.

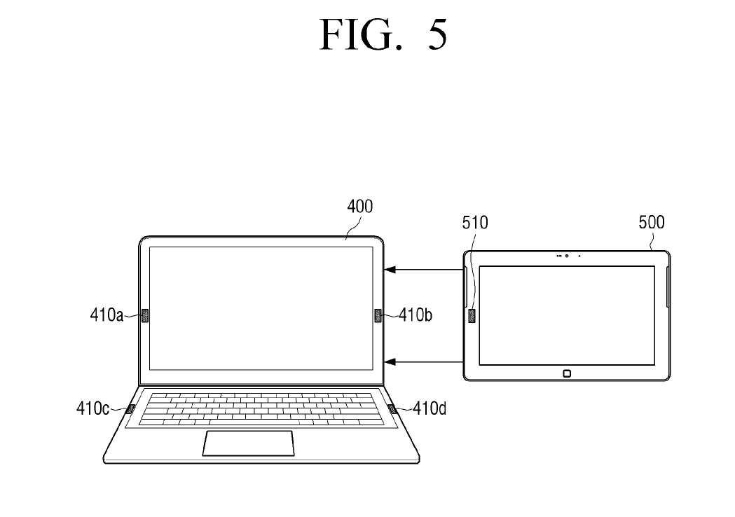

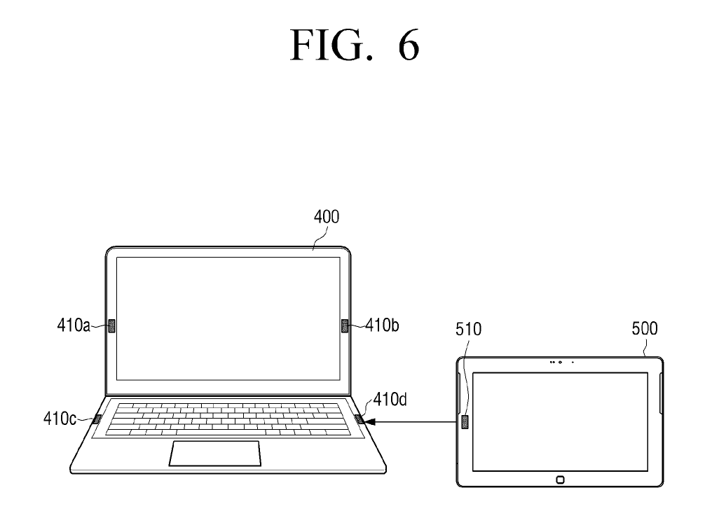

FIGS. 5 and 6 are views illustrating the electronic device 400 of FIG. 4 according to an exemplary embodiment of the present general inventive concept.

In the exemplary embodiment, the electronic device 400 is a notebook PC, and an external device 500 is a tablet PC, but this is only an example and the present general inventive concept is not limited thereto.

The electronic device 400 may have a plurality of sensors 410a, 410b, 410c, and 410d at different locations. The external device 500 may have at least one sensor 510. When the external device 500 approaches or is disposed close to at least one of the sensors 410a, 410b, 410c, and 410d of the electronic device 400 within a predetermined distance, the sensor 510 of the external device 500 activates the at least one of the sensors 410a, 410b, 410c, and 410d.

According to an exemplary embodiment, the sensors 410a, 410b, 410c, and 410d of the electronic device 400 may be Hall IC sensors, and the sensor 510 of the external device 500 may include a magnetic material to activate the Hall IC sensors.

In response to the external device 500 being connected to an upper side of the electronic device 400 by a user, the sensor 410b at the corresponding location is activated. In this case, the detector 430 outputs a signal corresponding to the activated sensor 410b, and the controller 450 receives the signal and recognizes that the external device 500 is connected to where the activated sensor 410b is located. Subsequently, the controller 450 executes an application corresponding to the location where the external device 500 is connected. For example, a user may connect the external device 500 to an upper right side of the electronic device 400 in order to use the external device 500 as a supplemental monitor and thus, an application to input setting information which is necessary to utilize the external device 500 as a supplemental monitor may be executed.

In addition, as illustrated in FIG. 6, in response to the external device 500 being connected to a lower right side of the electronic device 400 by a user, the corresponding sensor 410d is activated, and the detector 430 outputs a signal corresponding to the activated sensor 410d.

The controller 450 determines that the electronic device 500 is connected within a predetermined distance from the activated sensor 410d based on the signal received from the detector 430. Subsequently, an application corresponding to the location of the external device 500 with respect to the electronic device 400 is executed.

If a user connects the external device 500 to the lower right side of the electronic device 400, it may indicate that the user may use the external device 500 as a track pad, the controller 450 may automatically execute an application to input setting information which is necessary to user the external device 500 as a track pad.

Meanwhile, FIGS. 5 and 6 illustrate that an application corresponding to the location of the external device 500 is executed automatically, but the controller 450 may execute an application corresponding to a type and a location of the external device 500.

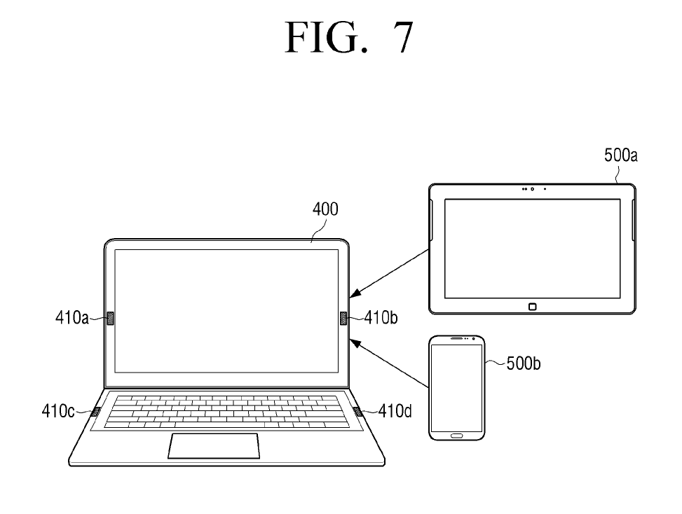

FIG. 7 is a view illustrating a method of executing an application corresponding to a type and a location of an external device according to an exemplary embodiment of general inventive concept.

The electronic device 400 may further include a communicator (not illustrated) to transmit/receive data to/from the external device 500 (500A and/or 500B). The communicator may be realized via cable or wirelessly, and may include a wired interface such as Universal Serial Bus (USB) and High Definition Multimedia Interface (HDMI) or a wireless interface such as WiFi, WiFi Direct, Bluetooth, RFID, etc. When the RFID is used in the communicator, the external device may have an RFID tag, and the electronic device 400 may have an RFID reader as a sensor and/or a detector. The RFID tag may include information (data) about the external device, for example, a type of the external device. The electronic device 400 may receive the information through a data communication of the RFID tag and the RFID reader.

The controller 450 may determine a location of external devices 500A and 500B based on a signal received from the detector 430 and the type of the external devices 500a and 500b based on data received through the communicator. For example, the tablet PC 500A and/or the smart phone 500B may be connected to a notebook PC which is the electronic device 400. If a user connects the smart phone 500B to the electronic device 400, purpose or usage of the smart phone 500B may be different from that of connecting the tablet PC 500A and thus, the controller 450 may execute an application corresponding to the smart phone 500B.

That is, if it is determined that an external device connected to the upper right side of the electronic device 400 is the tablet PC 500A, the controller 450 may automatically execute an application to input setting information which is necessary to utilize the tablet PC 500A as a supplemental monitor, and if it is determined that the smart phone 500B is connected, the controller 450 may automatically execute an application to input setting information which is necessary to use the smart phone 500B as a web cam. Subsequently, in response to the setting information being input, the controller 450 may control the external device to perform a corresponding operation according to the input setting information.

For example, in response to a specific resolution being set when an external device is utilized as a supplemental monitor, the controller 450 may control the external device to display various contents according to the set resolution.

As described above, the type and location of the external device which is connected to the electronic device 400 are determined and a corresponding application is executed automatically. Accordingly, a user does not need to manually select and execute a necessary application and input necessary setting information.

Meanwhile, the type of applications which are executed automatically according to the type and location of external devices may be changed by a user.

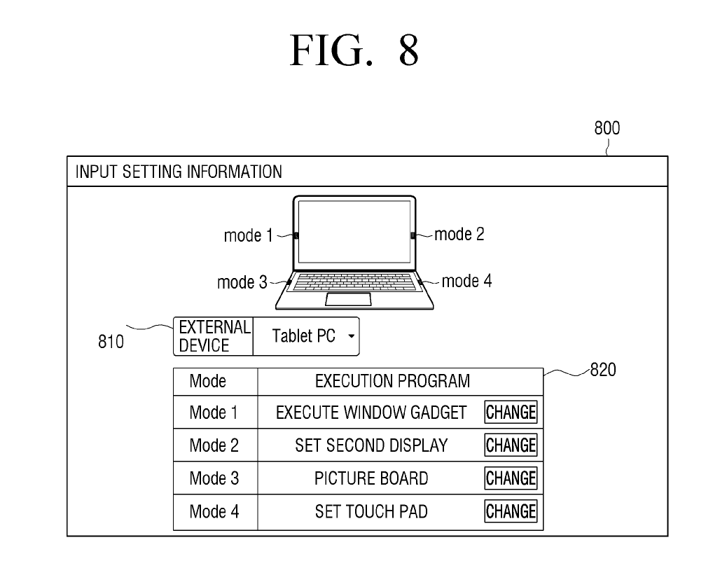

FIG. 8 is a view illustrating a setting information window 800 as a user interface UI to set a type of an application which is executed automatically according to an exemplary embodiment of the present general inventive concept.

In the exemplary embodiment, an electronic device is a notebook PC having a total of four sensors, but the present general inventive concept is not limited thereto. It is possible that other electronic devices than a notebook PC may be used and the other electronic device may have more or less than four sensors.

The setting information window 800 may include an input window 810 to select the type of an external device and a window 820 to set an application which is executed automatically according to the location where the external device is connected to the electronic device 400. The setting information window 800 is displayed on a screen of a display unit of the electronic device, and the setting information window may include a view illustrating the electronic device with one or more sensors, for example, four sensors corresponding to modes 1 through 4.

Through the input window 810 to select the type of an external device, a user may select various types of applications to connect to the electronic device 400. In the exemplary embodiment, an external device to be connected to the electronic device 400 is a tablet PC, but other various external devices such as smart phone, external monitor, PDA, etc. may also be connected to the electronic device 400.

In response to selection of the type of external device to be connected to the electronic device 400 by a user, the input window 820 is activated (displayed) to set an application which is executed automatically according to the location where the external device is connected.

The window 820 may include execution programs (applications) corresponding to the modes 1 through 4. For example, the mode 1 is set to execute a window gadget program, the mode 2 is set to execute a program to set a second display, the mode 3 is set to execute a picture board program, and the mode 4 is set to an application to set a touch pad. In a case where in response to connecting a tablet PC to a lower right side of the electronic device 400 by a user, that is, in response to connecting a tablet PC to a Mode 4 location, “Touch Pad Setting” application is executed automatically, but in response to selecting “Change” key to connect a tablet PC to the Mode 4 location by a user, the type of application which is executed automatically may be changed. For example, when a user selects a change button of the mode 4 in the window 820, the program of setting a touch pad is changed to another program of setting a second display. The execution programs of the window 820 as illustrated in FIG. 8 may be set as a default program when the setting information window 800 is displayed. It is possible that when the external device is disposed close to a sensor corresponding to the mode 2, the external device is automatically usable as a second display according to the default program of the mode 2.

Accordingly, in response to connecting an electronic device to an external device, a user may set the type of an application corresponding to a location where the external device is connected in advance and execute the application automatically and thus, the user does not have to execute a necessary application manually whenever the external is connected. A user may set the type of the application corresponding to the location (mode), and then when the electronic device is connected to the external device, the application corresponding to the location (mode) is automatically executes.

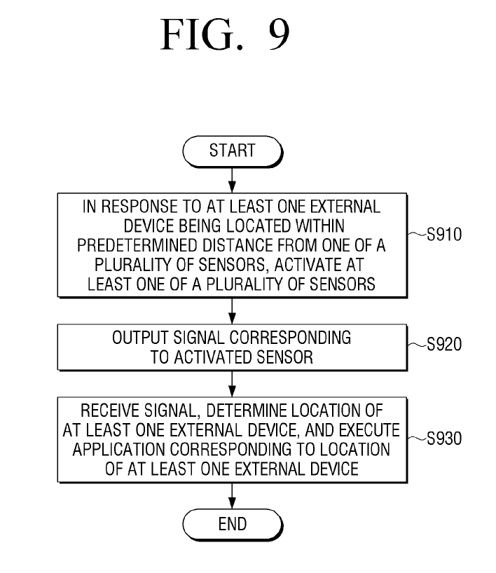

FIG. 9 is a view illustrating a method of executing an application of an electronic device according to an exemplary embodiment of the present general inventive concept.

In response to at least one external device being located within a predetermined distance from one of a plurality of sensors, one of a plurality of sensors is activated at operation S910.

For example, if a sensor is a Hall IC sensor, and an external device includes a magnetic material, the sensor is activated in response to the external device being located within a predetermined distance from the sensor. Subsequently, the sensor 430 outputs a signal corresponding to the activated sensor at operation S920. As the electronic device 400 may have a plurality of sensors at different locations, in response to a sensor at a specific location being activated, a signal corresponding to the sensor is output.

The controller 450 receives the signal from the detector 430, determines a location of the external device with respect to the electronic device, and executes an application corresponding to the location. In this case, the controller 430 may determine that the external device is located within a predetermined distance from the activated sensor.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

The location of an external device with respect to an electronic device is determined, and an application corresponding to the location is executed automatically, so user convenience can be enhanced. In addition, a user may execute an application for controlling an external device through a simple manipulation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic device connectable to at least one external device, comprising:
a plurality of sensors configured to be activated in response to the at least one external device being located within a predetermined distance;
a detector configured to, in response to at least one sensor from among the plurality of sensors being activated, output a signal corresponding to the activated sensor; and
a controller configured to receive the signal corresponding to the activated sensor from the detector, determine a location of the at least one external device, and execute an application corresponding to the location of the at least one external device.

2. The electronic device of claim 1, wherein the controller determines that the at least one external device is located within the predetermined distance from the activated sensor from among the plurality of sensors.

3. The electronic device of claim 1, further comprising:
a communicator configured to transmit/receive data to/from the at least one external device.

4. The electronic device of claim 3, wherein the controller determines a type of the at least one external device based on data received from the at least one external device, and executes the application corresponding to the type and location of the at least one external device.

5. The electronic device of claim 1, wherein the controller, in response to setting information being input from the application, controls the at least one external device to perform an operation corresponding to the setting information.

6. The electronic device of claim 1, further comprising:
a storage configured to store the application which is executed in accordance with the location of the at least one external device.

7. The electronic device of claim 1, wherein:
the plurality of sensors include a Hall IC sensor; and
in response to a magnetic field with more than a predetermined magnitude being detected by one of the plurality of sensors, the sensor which detects the magnetic field is activated.

8. The electronic device of claim 1, wherein the controller provides a user interface to change the application which is executed in accordance with the location of the at least one external device.

9. A method of executing an application of an electronic device connectable to at least one external device, the method comprising:
in response to the at least one external device being located within a predetermined distance from one of a plurality of sensors, activating at least one of the plurality of sensors;
outputting a signal corresponding to the activated sensor; and
receiving the signal corresponding to the activated sensor, determining a location of the at least one external device, and executing an application corresponding to the location of the at least one external device.

10. The method of claim 9, further comprising:
determining that the at least one external device is located within the predetermined distance from the activated sensor.

11. The method of claim 9, further comprising:
transmitting/receiving data to/from the at least one external device.

12. The method of claim 11, further comprising:
determining a type of the at least one external device based on data received from the at least one external device; and
executing the application corresponding to the type and location of the at least one external device.

13. The method of claim 9, further comprising:
receiving setting information from the application; and
controlling the at least one external device to perform an operation corresponding to the setting information.

14. The method of claim 9, further comprising:
storing the application which is executed in accordance with the location of the at least one external device.

15. The method of claim 9, wherein:
the plurality of sensors include a Hall IC sensor; and
the activating the at least one of the plurality of sensors comprises:
in response to a magnetic field with more than a predetermined magnitude being detected by one of the plurality of sensors, activating the sensor which detects the magnetic field.

16. The method of claim 9, further comprising:
providing a user interface to change the application which is executed in accordance with the location of the at least one external device.

17. A non-transitory computer-readable medium containing computer-readable codes as a program to execute the method of claim 9.
